(19) United States
(12) Patent Application Publication
(10) Pub. No.: US 2014/0049699 A1
(43) Pub. Date: Feb. 20, 2014

(54) POLARIZING PLATE, TOUCH LIQUID CRYSTAL PANEL AND TOUCH DISPLAY

(71) Applicant: CHUNGHWA PICTURE TUBES, LTD., Padeh City (TW)

(72) Inventors: Shao-Keng HUANG, Zhongli City (TW); Sheng-Hui CHANG, Taichung City (TW); Yu-Cheng TUNG, Kaohsiung City (TW)

(73) Assignee: CHUNGHWA PICTURE TUBES, LTD., Padeh City (TW)

(21) Appl. No.: 13/764,116

(22) Filed: Feb. 11, 2013

(30) Foreign Application Priority Data
Aug. 17, 2012 (TW) 101129918

(51) Int. Cl. G02B 5/30; G02F 1/1333

(52) U.S. Cl. CPC G02B 5/3016; G02F 1/13338
USPC 349/12; 359/483.01

(57) ABSTRACT

A polarizing plate includes a first substrate layer, a polarizing layer, a second substrate layer, a pressure sensitive adhesive layer and a light-shielding pattern. The polarizing layer is disposed on the first substrate layer. The second substrate layer is disposed on the polarizing layer, whereby the polarizing layer is located between the first substrate layer and the second substrate layer. The pressure sensitive adhesive layer is formed on a bottom surface of the first substrate layer, whereby the first substrate layer located between the polarizing layer and the pressure sensitive adhesives layer. The light-shielding pattern is formed between the second substrate layer and the pressure sensitive adhesives layer.

### CROSS-REFERENCE TO RELATED APPLICATION

This application claims the benefit of Taiwan Patent Application No. 101129918, filed on Aug. 17, 2012, which is hereby incorporated by reference for all purposes as if fully set forth herein.

### BACKGROUND OF THE INVENTION

1. Field of Invention

This invention relates to a polarizing plate, and more particularly to a polarizing plate having a higher stiffness and a touch liquid crystal panel and a touch display using the polarizing plate.

2. Related Art

A touch panel is widely used by the people and become a kind of interface tools of information communication. Currently, the widely used touch panel has two types: a resistance type and a capacity type.

FIG. 1 is a cross-sectional schematic view of a touch display in the prior art. A typical touch display 900 is a multi-layer structure which includes a cover lens 910, a liquid crystal display module 930 and a touch sensor layer 920 disposed between the cover lens 910 and the liquid crystal display module 930. Conventional touch panel must utilize 1˜2 pieces of glasses to manufacture the touch sensor layer, and also includes the cover lens, such that the thickness of the touch panel is increased, the design is difficult, the cost is increased, and the manufacture time is increased.

Accordingly, there exists a need for a polarizing plate and a touch liquid crystal panel and a touch display using the polarizing plate, wherein the polarizing plate replaces a cover lens and is capable of solving the above-mentioned problems.

### SUMMARY OF THE INVENTION

It is an objective of the present invention to provide a polarizing plate having a high stiffness and capable of overcoming the conventional polarizing plate which is too soft to have enough bending strength and compressive strength.

It is another objective of the present invention to overcome the conventional touch liquid crystal panel which is too thick and light, wherein a touch liquid crystal panel is manufactured by using a polarizing plate having a high stiffness, whereby the touch liquid crystal panel is lighter and thinner.

It is a further objective of the present invention to overcome the conventional touch liquid crystal panel which is too thick and light, wherein a polarizing plate having a high stiffness is used to replace a cover lens, whereby the touch liquid crystal panel is lighter and thinner.

It is another further objective of the present invention to overcome the conventional touch display which is too thick and light, wherein a touch display is manufactured by using a polarizing plate having the high stiffness, whereby the touch liquid crystal panel is lighter and thinner.

In order to achieve the objective, the present invention provides a polarizing plate comprising:
a first substrate layer;
a polarizing layer disposed on the first substrate layer;
a second substrate layer disposed on the polarizing layer, whereby the polarizing layer is located between the first substrate layer and the second substrate layer;
a pressure sensitive adhesive layer formed on a bottom surface of the first substrate layer, whereby the first substrate layer is located between the polarizing layer and the pressure sensitive adhesives layer; and
a light-shielding pattern formed between the second substrate layer and the pressure sensitive adhesives layer.

In order to achieve the objective, the present invention further provides a touch liquid crystal panel comprising:
a first polarizing plate;
a thin film transistor substrate disposed above the first polarizing plate;
a liquid crystal layer disposed above the thin film transistor substrate, whereby the thin film transistor substrate is located between the first polarizing plate and the liquid crystal layer;
a color filter substrate disposed above the liquid crystal layer;
a second polarizing plate disposed above the color filter substrate, whereby the color filter substrate is located between the liquid crystal layer and the second polarizing plate, wherein the second polarizing plate comprises:
   a first substrate layer;
   a polarizing layer disposed on the first substrate layer;
   a second substrate layer disposed on the polarizing layer, whereby the polarizing layer is located between the first substrate layer and the second substrate layer;
   a pressure sensitive adhesive layer formed on a bottom surface of the first substrate layer, whereby the first substrate layer is located between the polarizing layer and the pressure sensitive adhesives layer; and
   a light-shielding pattern formed between the second substrate layer and the pressure sensitive adhesives layer; and
a touch sensor layer located between the second polarizing plate and the thin film transistor substrate.

The present invention further provides a touch display comprising:
a touch liquid crystal panel comprising:
   a first polarizing plate;
   a thin film transistor substrate disposed above the first polarizing plate;
   a liquid crystal layer disposed above the thin film transistor substrate, whereby the thin film transistor substrate is located between the first polarizing plate and the liquid crystal layer;
   a color filter substrate disposed above the liquid crystal layer;
   a second polarizing plate disposed above the color filter substrate, whereby the color filter substrate is located between the liquid crystal layer and the second polarizing plate, wherein the second polarizing plate comprises:
      a first substrate layer; a polarizing layer disposed on the first substrate layer;
      a second substrate layer disposed on the polarizing layer, whereby the polarizing layer is located between the first substrate layer and the second substrate layer;
      a pressure sensitive adhesive layer formed on a bottom surface of the first substrate layer, whereby the first substrate layer is located between the polarizing layer and the pressure sensitive adhesives layer; and
      a light-shielding pattern formed between the second substrate layer and the pressure sensitive adhesives layer; and
   a touch sensor layer located between the second polarizing plate and the thin film transistor substrate; and
a backlight module adapted to provide a light source to the touch liquid crystal panel.

The thicknesses of first substrate layer and the second substrate layer of the polarizing plate of the present invention are increased, whereby the polarizing plate can replace the cover lens. Thus, the touch liquid crystal panel and the touch display using the polarizing plate of the present invention can meet the thin requirement, and the weights of the touch liquid crystal panel and the touch display are decreased.

In addition, the light-shielding pattern is added to the polarizing plate, and can be adapted to shield circuit lines and electronic components of the touch liquid crystal panel and the touch display, wherein the touch liquid crystal panel and the touch display include the polarizing plate, thereby increasing the visually beautiful effect.

In order to make the aforementioned and other objectives, features and advantages of the present invention comprehensible, embodiments are described in detail below with reference to the accompanying drawings.

### BRIEF DESCRIPTION OF THE DRAWINGS

FIG. 1 is a cross-sectional schematic view of a touch display in the prior art;

FIG. 2 is a cross-sectional schematic view of a polarizing plate according to the first embodiment of the present invention;

FIG. 3 is a top view of a polarizing plate according to the first embodiment of the present invention;

FIG. 4 is a cross-sectional schematic view of a polarizing plate according to the second embodiment of the present invention;

FIG. 5 is a cross-sectional schematic view of a polarizing plate according to the third embodiment of the present invention;

FIGS. 6a and 6b are cross-sectional schematic views of a touch liquid crystal panel according to the first embodiment of the present invention;

FIG. 7 is a cross-sectional schematic view of a touch liquid crystal panel according to the second embodiment of the present invention;

FIG. 8 is a cross-sectional schematic view of a touch liquid crystal panel according to the third embodiment of the present invention; and

FIG. 9 is a cross-sectional schematic view of a touch display of the present invention.

The present invention will become more fully understood from the detailed description given herein below for illustration only, and thus are not limitative of the present invention, and wherein:

### DETAILED DESCRIPTION OF THE INVENTION

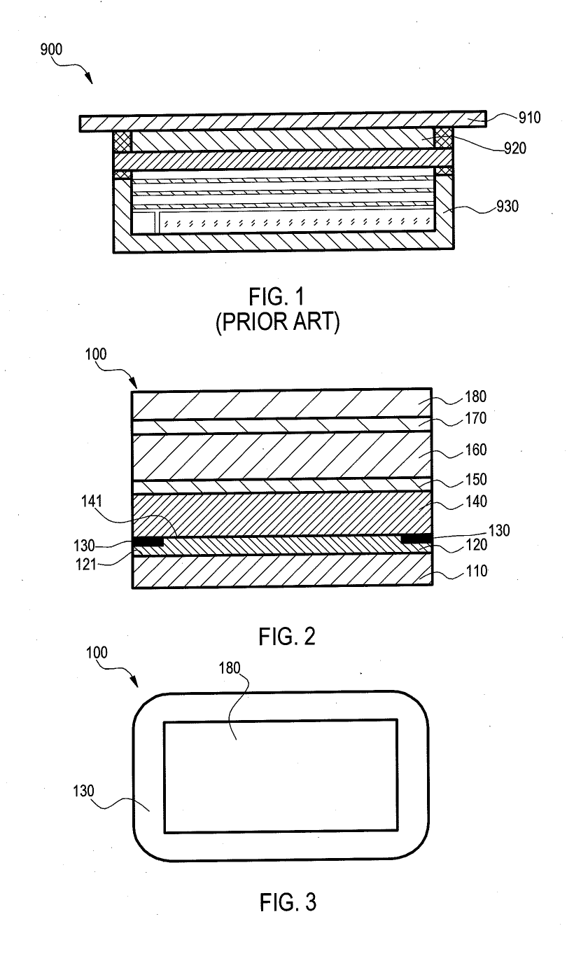

FIG. 2 is a cross-sectional schematic view of a polarizing plate according to the first embodiment of the present invention. As shown in FIG. 2, the polarizing plate 100 includes a first protective film 110, a second protective film 180, a pressure sensitive adhesive layer 120, a light-shielding pattern 130, a first substrate layer 140, a second substrate layer 160, a polarizing layer 150 and a surface treatment layer 170.

In the first embodiment of the present invention, the polarizing layer 150 is disposed on the first substrate layer 140. The second substrate layer 160 is disposed on the polarizing layer 150, whereby the polarizing layer 150 is located between the first substrate layer 140 and the second substrate layer 160. The polarizing layer 150 can be a Poly Vinyl Alcohol (PVA), but not intended to limit the present invention. For example, the PVA is a soft and transparent plastic material, and includes iodine ions penetrated thereinto so as to have an arrangement direction, whereby an electric field component of a light beam being parallel to the arrangement direction is absorbed, and only an electric field component of a light beam being perpendicular to the arrangement direction is passed.

The first substrate layer 140 and the second substrate layer 160 can be triacetyl cellulose (TAC), diacetyl cellulose (DAC). polyethylene terephthalate (PET), cycloolefin polymer (COP), cycloolefin copolymer (COC), polycarbonate (PC) or similar materials for mainly protecting the polarizing layer 150. Also, the thickness of each of the first substrate layer 140 and the second substrate layer 160 is more than 80 μm, and the sum of the thicknesses of the first substrate layer 140 and the second substrate layer 160 is between 160 μm and 780 μm, thereby increasing the bending strength and the compressive strength of the polarizing plate 100 (i.e., the stiffness of the polarizing plate 100 is increased). The polarizing effect of the polarizing layer 150 is not changed when an external force is applied. If the polarizing plate 100 replaces a cover lens of a touch liquid crystal panel or a touch display, the polarizing plate 100 not only keeps original polarizing effect but also cause the touch liquid crystal panel or the touch display to be lighter and thinner.

The surface treatment layer 170 is formed on the second substrate layer 160. The second protective film 180 is disposed on the surface treatment layer 170, whereby the surface treatment layer 170 is located between the second protective film 180 and the second substrate layer 160. The surface treatment layer 170 can include at least one of a hard resin coating layer (HC), an anti-glare coating layer (AG), an anti-reflection coating layer (AR), an anti-static coating layer (AS) and a wide view coating layer (WV). The polarizing plate 100 can have hard, anti-glare, anti-reflection, anti-static and wide view functions by the surface treatment layer 170. If the polarizing plate 100 of the present invention does not need hard, anti-glare, anti-reflection, anti-static and wide view functions, the surface treatment layer 170 is unnecessary.

In the first embodiment of the present invention, the light-shielding pattern 130 can be formed on a bottom surface 141 of the first substrate layer 140 by means of a printing manner, whereby the light-shielding pattern 130 is located between the first substrate layer 140 and the pressure sensitive adhesives layer 120. The light-shielding pattern 130 can be annular, and annularly disposed on the bottom surface 141 of the first substrate layer 140. The light-shielding pattern 130 can be made of various organic materials, such as resin (the thickness is between 5 μm and 15 μm). The resin can be black resin or a gray resin, etc. The resin can be further doped with a substance, which can be metal (e.g. chromium), metallic oxide (e.g. chromium oxide), mixture thereof or nonmetal (e.g. carbon), etc. For example, the material of the light-shielding pattern 130 can be a brown resin formed by a novalac polymer resin and a positive photosensitive dye, a black resin formed by an acrylic ester adhesive and a positive photosensitive color pigment, or a black resin formed by an acrylic acid monomer and a negative black pigment, etc.

In another embodiment, referring to FIG. 2 again, the light-shielding pattern 130 can be formed on the bottom surface 141 of the first substrate layer 140 by means of a sputtering manner, whereby the light-shielding pattern 130 is located between the first substrate layer 140 and the pressure sensitive adhesives layer 120. Also, the light-shielding pattern 130 can be made of metallic material.

The pressure sensitive adhesive layer 120 is formed on the bottom surface 141 of the first substrate layer 140, and covers the light-shielding pattern 130, whereby the first substrate layer 140 is located between the polarizing layer 150 and the pressure sensitive adhesives layer 120. The first protective film 110 is disposed on a bottom surface 121 of the pressure sensitive adhesives layer 120. The pressure sensitive adhesive layer 120 is a kind of adhesive, which can be adhered to an object surface by a slight press, and is constituted by an elastomer, a tackifying resin, a plasticizer and a filler. The property of the pressure sensitive adhesive layer 120 depends on the used monomer, the polymerization manner, the molecular weight of the controlled colloid, or the glass transition temperature. The typical pressure sensitive adhesive layer 120 can be a natural rubber, a styrene butadiene rubber (SBR), an acrylic resin (acrylic ester copolymer), etc.

FIG. 3 is a top view of a polarizing plate according to the first embodiment of the present invention. The light-shielding pattern 130 is disposed around a periphery of the polarizing plate 100, and is adapted to shield circuit lines and electronic components of a touch liquid crystal panel and a touch display, wherein the touch liquid crystal panel and the touch display include the polarizing plate, thereby increasing the visually beautiful effect.

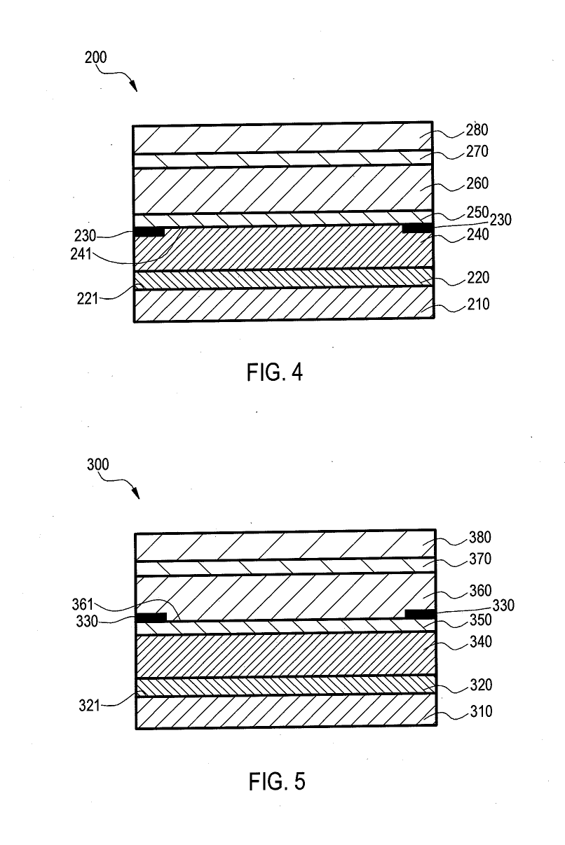

FIG. 4 is a cross-sectional schematic view of a polarizing plate according to the second embodiment of the present invention. The polarizing plate 200 in the second embodiment is substantially similar to the polarizing plate 100 in the first embodiment. The difference between the polarizing plate 200 in the second embodiment and the polarizing plate 100 in the first embodiment is that: the position that the light-shielding pattern 230 is formed.

The light-shielding pattern 230 in the second embodiment is formed on a top surface 241 of the first substrate layer 240 by means of a sputtering manner, whereby the light-shielding pattern 230 is located between the polarizing layer 250 and the first substrate layer 240. The light-shielding pattern 230 is annular, and annularly disposed around the top surface 241 of the first substrate layer 240. The thickness of the light-shielding pattern 230 must be less than 0.45 μm so as to avoid affecting the optical property of the polarizing layer 250. The light-shielding pattern 230 can be made of metal material. In addition, the structure, position and material of the first protective layer 210, the second protective film 280, the pressure sensitive adhesive layer 220, the second substrate layer 260 and the surface treatment layer 270 are the same as those in the first embodiment, and thus do not need to be repeatedly described.

FIG. 5 is a cross-sectional schematic view of a polarizing plate according to the third embodiment of the present invention. The polarizing plate 300 in the third embodiment is substantially similar to the polarizing plate 100 in the first embodiment. The difference between the polarizing plate 300 in the third embodiment and the polarizing plate 100 in the first embodiment is that: the position of the light-shielding pattern 330.

The light-shielding pattern 330 is formed on a bottom surface 361 of the second substrate layer 360 by means of a sputtering manner, whereby the light-shielding pattern 330 is located between the polarizing layer 350 and the second substrate layer 360. The light-shielding pattern 330 is annular, and annularly disposed on the bottom surface 361 of the second substrate layer 360. The thickness of the light-shielding pattern 330 must be less than 0.45 μm so as to avoid affecting the optical property of the polarizing layer 350. The light-shielding pattern 330 can be made of metal material. In addition, the structure, position and material of the first protective film 310, the second protective film 380, the pressure sensitive adhesive layer 320, the second substrate layer 360 and the surface treatment layer 370 are the same as those in the first embodiment, and thus do not need to be repeatedly described.

According to the polarizing plate in the first, second and third embodiments, it is noted that: the light-shielding pattern can be located between the first substrate layer and the pressure sensitive adhesives layer, the light-shielding pattern can be located between the first substrate layer and the polarizing layer, or the light-shielding pattern can be located between the second substrate layer and the polarizing layer. In other words, the light-shielding pattern can be formed between the second substrate layer and the pressure sensitive adhesives layer.

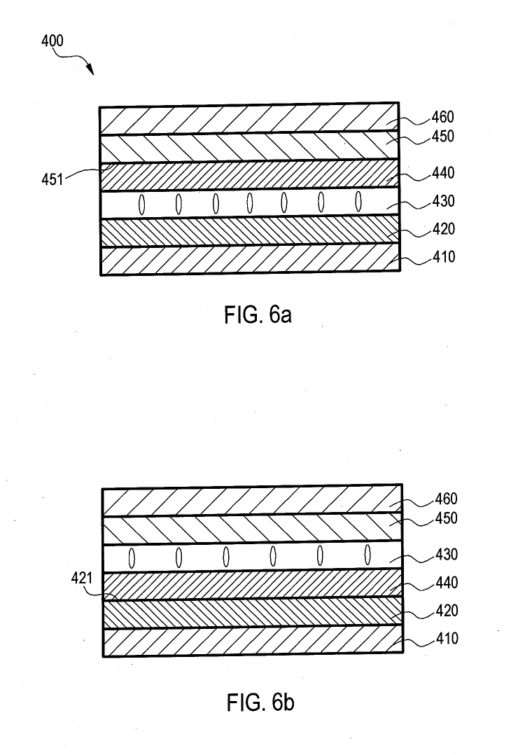

As shown in FIG. 6a, it is a cross-sectional schematic view of a touch liquid crystal panel according to the first embodiment of the present invention. The touch liquid crystal panel 400 includes a first polarizing plate 410, a color filter substrate 450, a thin film transistor substrate 420, a liquid crystal layer 430, a second polarizing plate 460 and a touch sensor layer 440. The touch sensor layer 440 is generally constituted by transparently conductive wires which are disposed longitudinally and transversely, crossed and separated from each other. The touch liquid crystal panel detects an inference of an electric field of the transparently conductive wires generated by a finger, and then reads a sensing signal generated from the longitudinally and transversely transparently conductive wires so as to determine a touch position.

The thin film transistor substrate 420 is disposed above the first polarizing plate 410. The liquid crystal layer 430 is disposed above the thin film transistor substrate 420, whereby the thin film transistor substrate 420 is located between the first polarizing plate 410 and the liquid crystal layer 430. In this embodiment, the touch sensor layer 440 is firstly formed on a bottom surface of the color filter substrate 450, then the color filter substrate 450 is disposed above the liquid crystal layer 430, whereby the touch sensor layer 440 is located between the color filter substrate 450 and the liquid crystal layer 430 (i.e., this is a design of Sensor in cell).

The second polarizing plate 460 is disposed above the color filter substrate 450, whereby the color filter substrate 450 is located between the touch sensor layer 440 and the second polarizing plate 460. The second polarizing plate 460 is the same as the polarizing plate in the first, second and third embodiments.

As shown in FIG. 6b, in another embodiment, the touch sensor layer 440 is firstly formed on a top surface 421 of the thin film transistor substrate 420, then the thin film transistor substrate 420 is disposed under the liquid crystal layer 430, whereby the touch sensor layer 440 is located between the thin film transistor substrate 420 and the liquid crystal layer 430 (i.e., this is a design of Sensor in cell, too). The second polarizing plate 460 is disposed above the color filter substrate 450, whereby the color filter substrate 450 is located between the liquid crystal layer 430 and the second polarizing plate 460. The second polarizing plate 460 is the same as the polarizing plate in the first, second and third embodiments.

The polarizing plate in the first, second and third embodiments have higher bending strength and compressive strength, the polarizing plate can be acted as the cover lens, and the polarizing plate also keeps original polarizing effect. Thus, the cover lens does not need to be acted as a touch surface of a user in the embodiment of the present invention so as to decrease the thickness and the weight of the touch liquid crystal panel.

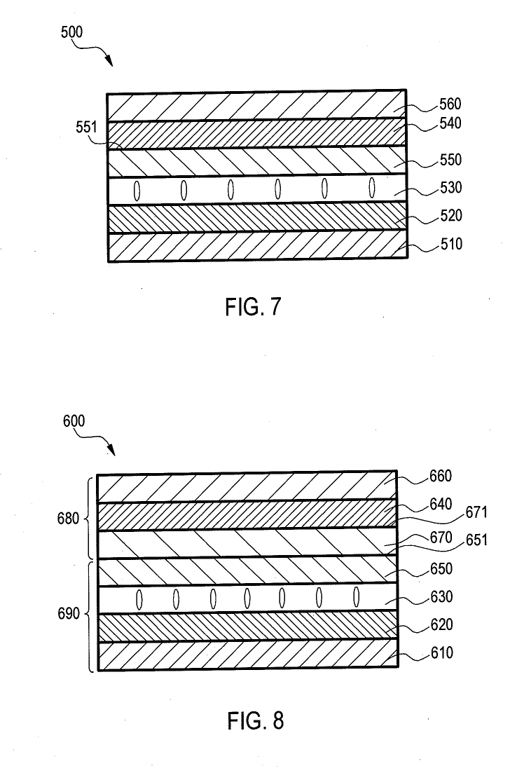

As shown in FIG. 7, it is a cross-sectional schematic view of a touch liquid crystal panel according to the second embodiment of the present invention. The touch liquid crystal panel 500 includes a first polarizing plate 510, a color filter substrate 550, a thin film transistor substrate 520, a liquid crystal layer 530, a second polarizing plate 560 and a touch sensor layer 540.

The thin film transistor substrate 520 is disposed above the first polarizing plate 510. The liquid crystal layer 530 is disposed above the thin film transistor substrate 520, whereby the thin film transistor substrate 520 is located between the first polarizing plate 510 and the liquid crystal layer 530. The color filter substrate 550 is disposed above the liquid crystal layer 530. The touch sensor layer 540 is disposed on a top surface 551 of the color filter substrate 550, whereby the color filter substrate 550 is located between the touch sensor layer 540 and the liquid crystal layer 530.

The second polarizing plate 560 is disposed above the touch sensor layer 540, whereby the touch sensor layer 540 is located between the color filter substrate 550 and the second polarizing plate 560, i.e., the touch sensor layer 540 is located between the second polarizing plate 560 and the liquid crystal layer 530. The second polarizing plate 560 is the same as the polarizing plate in the first, second and third embodiments.

The polarizing plate in the first, second and third embodiments have higher bending strength and compressive strength, the polarizing plate can be acted as the cover lens, and the polarizing plate also keeps original polarizing effect. Thus, the cover lens does not need to be acted as a touch surface of a user in the embodiment of the present invention so as to decrease the thickness and the weight of the touch liquid crystal panel.

As shown in FIG. 8, it is a cross-sectional schematic view of a touch liquid crystal panel according to the third embodiment of the present invention. The touch liquid crystal panel 600 includes a first polarizing plate 610, a color filter substrate 650, a thin film transistor substrate 620, a liquid crystal layer 630, a second polarizing plate 660, a transparent substrate 670 and a touch sensor layer 640.

The thin film transistor substrate 620 is disposed above the first polarizing plate 610. The liquid crystal layer 630 is disposed above the thin film transistor substrate 620, whereby the thin film transistor substrate 620 is located between the first polarizing plate 610 and the liquid crystal layer 630. The color filter substrate 650 is disposed above the liquid crystal layer 630 so as to form a liquid crystal panel 690.

The touch sensor layer 640 is formed on a top surface 671 of the transparent substrate 670, whereby the transparent substrate 670 is located between the touch sensor layer 640 and the color filter substrate 650; and the second polarizing plate 660 is disposed above the touch sensor layer 640, whereby the touch sensor layer 640 is located between the second polarizing plate 660 and the transparent substrate 670. The above-mentioned second polarizing plate 660, the touch sensor layer 640 and the transparent substrate 670 are combined to a touch panel 680. The touch panel 680 is combined to the liquid crystal panel 690, and the transparent substrate 670 is disposed a top surface 651 of the color filter substrate 650 so as to a touch liquid crystal panel 600. The second polarizing plate 660 is the same as the polarizing plate in the first, second and third embodiments.

According to the touch liquid crystal panel 600 in the third embodiment of the present invention, the liquid crystal panel 690 and the touch panel 680 are manufactured independently, and finally the liquid crystal panel 690 is combined to the touch panel 680. This manufacturing method can avoid discarding the whole touch liquid crystal panel when one of the liquid crystal panel 690 and the touch panel 680 has a defect problem during manufacturing, thereby decreasing the manufacture cost.

The polarizing plate in the first, second and third embodiments have higher bending strength and compressive strength, the polarizing plate can be acted as the cover lens, and the polarizing plate also keeps original polarizing effect. Thus, the cover lens does not need to be acted as a touch surface of a user in the embodiment of the present invention so as to decrease the thickness and the weight of the touch liquid crystal panel.

According to the touch liquid crystal panel in the first, second and third embodiments, it is noted that: the touch sensor layer can be located between the color filter substrate and the liquid crystal layer, the touch sensor layer can be located between the thin film transistor substrate and the liquid crystal layer, the touch sensor layer can be located between the second polarizing plate and the color filter substrate, or the touch sensor layer can be located between the second polarizing plate and the transparent substrate. In other words, the touch sensor layer can be located between the second polarizing plate and the thin film transistor substrate.

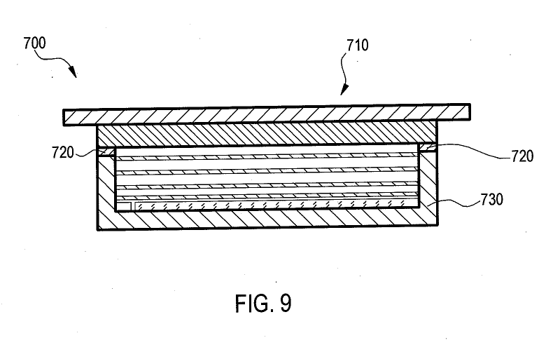

As shown in FIG. 9, it is a cross-sectional schematic view of a touch display of the present invention. The touch display 700 includes a touch liquid crystal panel 710, an adhesive layer 720 and a backlight module 730.

The backlight module 730 is adapted to provide a light source to the touch liquid crystal panel 710. The touch liquid crystal panel 710 is attached to the backlight module 730 by the adhesive layer 720, whereby the touch liquid crystal panel 710 and the backlight module 730 are mounted to each other. The adhesive layer 720 can be a twin adhesive, a liquid optically clear adhesive (OCA) or an optical clear resin (OCR).

The structure of the touch liquid crystal panel of the touch display of the present invention is the same as those in the first, second and third embodiments, and thus does not need to be repeatedly described.

The thicknesses of first substrate layer and the second substrate layer of the polarizing plate of the present invention are increased, whereby the polarizing plate can replace the cover lens. Thus, the touch liquid crystal panel and the touch display using the polarizing plate of the present invention can meet the thin requirement, and the weights of the touch liquid crystal panel and the touch display are decreased.

In addition, the light-shielding pattern is added to the polarizing plate, and can be adapted to shield circuit lines and electronic components of the, touch liquid crystal panel and the touch display, wherein the touch liquid crystal panel and the touch display include the polarizing plate, thereby increasing the visually beautiful effect.

To sum up, the implementation manners or embodiments of the technical solutions adopted by the present invention to solve the problems are merely illustrative, and are not intended to limit the scope of the present invention. Any equivalent variation or modification made without departing from the scope or spirit of the present invention shall fall within the appended claims of the present invention.

What is claimed is:

1. A polarizing plate comprising:
a first substrate layer;
a polarizing layer disposed on the first substrate layer;
a second substrate layer disposed on the polarizing layer, whereby the polarizing layer is located between the first substrate layer and the second substrate layer;
a pressure sensitive adhesive layer formed on a bottom surface of the first substrate layer, whereby the first substrate layer is located between the polarizing layer and the pressure sensitive adhesives layer; and
a light-shielding pattern formed between the second substrate layer and the pressure sensitive adhesives layer.

2. The polarizing plate as claimed in claim 1, wherein the sum of the thicknesses of the first substrate layer and the second substrate layer is between 160 μm and 780 μm.

3. The polarizing plate as claimed in claim 1, further comprising a surface treatment layer formed on the second substrate layer, wherein the surface treatment layer comprises at least one of a hard resin coating layer, an anti-glare coating layer, an anti-reflection coating layer, an anti-static coating layer and a wide view coating layer.

4. The polarizing plate as claimed in claim 1, wherein the light-shielding pattern is disposed on the bottom surface of the first substrate layer, whereby the light-shielding pattern is located between the first substrate layer and the pressure sensitive adhesives layer, and is annularly disposed on the bottom surface of the first substrate layer.

5. The polarizing plate as claimed in claim 1, wherein the light-shielding pattern is disposed on a top surface of the first substrate layer, whereby the light-shielding pattern is located between the first substrate layer and the polarizing layer, and is annularly disposed on the top surface of the first substrate layer.

6. The polarizing plate as claimed in claim 1, wherein the light-shielding pattern is disposed on a bottom surface of the second substrate layer, whereby the light-shielding pattern is located between the second substrate layer and the polarizing layer, and is annularly disposed on the bottom surface of the second substrate layer.

7. The polarizing plate as claimed in claim 1, wherein the light-shielding pattern is made of resin material or metal material.

8. A touch liquid crystal panel comprising:
a first polarizing plate;
a thin film transistor substrate disposed above the first polarizing plate;
a liquid crystal layer disposed above the thin film transistor substrate, whereby the thin film transistor substrate is located between the first polarizing plate and the liquid crystal layer;
a color filter substrate disposed above the liquid crystal layer;
a second polarizing plate disposed above the color filter substrate, whereby the color filter substrate is located between the liquid crystal layer and the second polarizing plate, wherein the second polarizing plate is the polarizing plate as claimed in claim 1; and
a touch sensor layer located between the second polarizing plate and the thin film transistor substrate.

9. The touch liquid crystal panel as claimed in claim 8, wherein the touch sensor layer is formed on a bottom surface of the color filter substrate, whereby the touch sensor layer is located between the color filter substrate and the liquid crystal layer.

10. The touch liquid crystal panel as claimed in claim 8, wherein the touch sensor layer is formed on a top surface of the thin film transistor substrate, whereby the touch sensor layer is located between the thin film transistor substrate and the liquid crystal layer.

11. The touch liquid crystal panel as claimed in claim 8, wherein the touch sensor layer is disposed on a top surface of the color filter substrate, whereby the touch sensor layer is located between the second polarizing plate and the color filter substrate.

12. The touch liquid crystal panel as claimed in claim 8, further comprising a transparent substrate disposed a top surface of the color filter substrate, wherein the touch sensor layer is formed on a top surface of the transparent substrate, whereby the transparent substrate is located between the touch sensor layer and the color filter substrate; and the second polarizing plate is disposed on the touch sensor layer, whereby the touch sensor layer is located between the second polarizing plate and the transparent substrate.

13. A touch display comprising:
a touch liquid crystal panel, being the touch liquid crystal panel as claimed in claim 8; and
a backlight module adapted to provide a light source to the touch liquid crystal panel.
